(19) United States
(12) Patent Application Publication
(10) Pub. No.: US 2001/0039712 A1
(43) Pub. Date: Nov. 15, 2001

(54) METHOD FOR MANUFACTURING A VEHICLE FRAME

(76) Inventors: PHILLIP C. RUEHL, ELM GROVE, WI (US); STEPHEN L. KRETSCHMER, MEQUON, WI (US)

Correspondence Address: CRAIG J. LERVICK, ESQ., OPPENHEIMER WOLFF & DONNELLY LLP, 45 SOUTH SEVENTH STREET, SUITE 3400, MINNEAPOLIS, MN, 55402

(21) Appl. No.: 09/295,104

(22) Filed: Apr. 15, 1999

Related U.S. Application Data
(60) Provisional application No. 60/082,050, filed on Apr. 15, 1998.

(51) Int. Cl. B23P 21/00; B23P 11/00

(52) U.S. Cl. 29/469; 29/897.2

(57) ABSTRACT

A rear vehicle frame is formed by placing a plurality of sheet members in a die in a press. At least some of the sheet members partially overlap other of the members. The press is then closed, thereby interlocking the members to form a rear vehicle frame having first and second siderails and at least one crossmember extending between the siderails. The method may include other steps and/or features. After the step of forming a rear vehicle frame, the respective rear siderails may be attached to first and second front siderails. The first and second siderails may overlap a portion of the first and second front rails, at least one of the first and second front rails comprising a scallop at the overlapped portion. The front siderails may each have an upper front siderail and a lower front side rail. There may be a step in between the center siderails and the lower front siderails. At least one of the upper front siderails has a scallop at one edge. The front siderails may be lipped, and the front siderails may be open. The front upper siderails may have tapered walls. The center siderail may have a lip that rolls out at a transition to the front siderail. The front siderail may have a tongue that is adapted to be attached to the center siderail. The frame may be a three-part frame, with rear, center and front sections, or it may be a two part frame, with rear and front sections. In a three-part frame, the rear section may connect with the center section in a manner analogous to the manner in which the center section interconnects with the front section.

### I. RELATED PATENT

The present invention is related to U.S. Pat. No. 5,487,219, which is entitled Method of Manufacturing Engine Cradles, which issued Jan. 30, 1996 and which is hereby incorporated by reference. This application claims priority from U.S. Provisional Application No. 60/082,050, which was filed on Apr. 15, 1998 and which is incorporated by reference herein.

### II. BACKGROUND OF THE INVENTION

A. Prior Art

A conventional pick-up truck structure has an isolated, rubber mounted front-frame-to-cab, and a hard mounted, bolted rear-frame-to-pick-up box. The front frame is usually designed with “closed” or “boxed” sections, with welded crossmembers and bracket joints. The purpose of the front frame is two-fold. First, the front frame isolates the passenger cab against noise, vibration, and harshness inputs. Various components are mounted on the front frame, including the engine, the transmission, the front suspension, and the steering. Each of these is mounted on an additional rubber layer to provide double isolation between the cab and the component. Second, the front frame provides strength, stiffness, crush, and dimensional control.

The rear frame is typically an “open”-section, riveted design, although some rear frames utilize a boxed/welded construction. The bolt attachment points on the bottom of the pick-up box floor are part of a lattice of intersecting lateral and fore-aft reinforcements whose “brims” are spot-welded to the box floor bottom. The rear-box-floor and rear-frame thus have some redundancy of structure.

The rear frame serves to mount the rear suspension, the fuel tank and the spare tire. It provides stiffness to limit the deflection of the box-section floor reinforcements, the “open” section frame system and the bolt joints between them. The rear frame that provides system dimensional control involves a stack of individual frame members, such as the box floor structural members, their assembly, their attachment to the floor, and the frame-to-box assembly.

The rear suspension is also isolated in rubber to maintain the double-isolation of the passenger cab. The front and rear frames are joined by frame center siderails to form a full pick-up truck frame.

FIG. 1 illustrates a greatly simplified prior art arrangement in which frame members of the pickup truck bed are disposed over the frame of a pickup truck 12. A plurality of elevating members 14 are placed atop a pair of frame members 16 of the truck 12 perpendicular with respect to a longitudinal axis of the frame 16. A longer elevating member 18 that has a length greater than that of the elevating members 14 is also shown similarly disposed on the frame 16. A mounting bracket 15 is attached, normally by welding, to the elevating members 14. The mounting bracket 15 is then attached to the frame 16 by drilling a hole (not shown) through the frame 16 and by the use of a bolt 17. Additional mounting brackets (not shown) are attached to any of the elevating members 14, the longer elevating member 18, or to any of the other component parts of the bed 10, to adequately attach the bed to the frame 16 of the truck 12.

The length of the longer elevating member 18 is selected so as to provide additional support for a pair of upstanding walls 28 and 30 (FIG. 2). The longer elevating member 18 is attached at both ends thereof to the lower edge of each of the pair of upstanding walls 28, 30 by a support bracket 29 that is bolted or welded thereto. Additional longer elevating members (not shown) are included as desired.

FIG. 3 illustrates a bed 10 on the truck 12 secured to the rear frame of the truck. A plurality of intermediate members 80 are attached at one end thereof to the top surface of each of the pair of upstanding walls 28, 30 and extend away from the longitudinal axis 62 to each of the main longitudinal frame members 58, 60 where they are each attached at a second end thereof to the main longitudinal frame members 58, 60.

The foregoing is only one example of a prior art rear pickup truck structure, and there are various other prior art arrangements. U.S. Pat. No. 5,511,848 discloses additional information about the particular structure that FIGS. 1-3 illustrate.

### III. SUMMARY OF INVENTION

The object of the present invention is to overcome shortcomings in prior art rear vehicle frame systems, particularly those relating to pick-up trucks. In accordance with one embodiment of the present invention, a method for efficiently manufacturing a vehicle frame includes several steps. A rear vehicle frame is formed by placing a plurality of sheet members in a die in a press. At least some of the sheet members partially overlap other of the members. The press is then closed, thereby interlocking the members to form a rear vehicle frame having first and second siderails and at least one crossmember extending between the siderails.

The method may include other steps and/or features. After the step of forming a rear vehicle frame, the respective rear siderails may be attached to first and second front siderails. The first and second siderails may overlap a portion of the first and second front rails, at least one of the first and second front rails comprising a scallop at the overlapped portion.

The siderails may have various features. The front siderails may each have an upper front siderail and a lower front side rail. There may be a step in between the center siderails and the lower front siderails. At least one of the upper front siderails has a scallop at one edge. The front siderails may be lipped, and the front siderails may be open.

The front upper siderails may have tapered walls. The center siderail may have a lip that rolls out at a transition to the front siderail. The front siderail may have a tongue that is adapted to be attached to the center siderail.

The frame may be a three-part frame, with rear, center and front sections, or it may be a two part frame, with rear and front sections. In a three-part frame, the rear section may connect with the center section in a manner analogous to the manner in which the center section interconnects with the front section.

According to another aspect of the invention, a method is provided to efficiently mount a pickup truck bed to a rear pickup truck frame. A rear vehicle frame is formed by placing a plurality of sheet members in a die in a press. At least some of the members at least partially overlap other of the members. The press is then closed to interlock the members to form a rear vehicle frame having first and second siderails and a plurality of crossmembers extending between and interconnecting with the siderails. After the rear pickup truck frame is formed, a pickup truck bed is mounted directly onto the crossmembers.

According to another aspect of the present invention, a space-efficient method for manufacturing a vehicle frame includes manufacturing a vehicle front frame at a first facility. The front frame is transported from the first facility to a second facility. A rear vehicle frame is formed at the second facility by placing a plurality of sheet members in a die in a press. At least some of the members at least partially overlap other of the members. The press is then closed, thereby interlocking the members to form a rear vehicle frame having first and second siderails and a plurality of crossmembers extending between and interconnecting with the siderails. The rear vehicle frame and the front frame are interconnected at the second facility to form a full vehicle frame.

Other objects and features of the invention will become apparent from a review of the Detailed Description below, from the drawings, and from the claims.

### IV. BRIEF DESCRIPTION OF THE DRAWINGS

FIG. 1 is a perspective view of crossmembers disposed over the frame of a pickup of a pickup truck;

FIG. 2 is a perspective view of pickup bed members disposed over the frame of a pickup truck;

FIG. 3 is a perspective view of the pickup truck bed attached to a pickup truck;

FIG. 4 is a perspective view of one embodiment of an integrated rear-frame/pickup box floor reinforcement;

FIG. 5 is an exploded perspective view of upper and lower die halves and six sheet metal blanks employed in a first press operation;

FIG. 6 is an elevational view of a press utilizing the upper and lower die halves;

FIG. 7 is a top plan view of the blanks properly arranged for forming in the first press operation;

FIG. 8 is an exploded perspective view of the formed and joined blanks after the first press operation along with four closing sheet blanks employed n a second press operation;

FIG. 9 is an exploded perspective view of the blanks shown in FIG. 9 after the second press operation and after arc welding of critical joints, along with additional brackets;

FIG. 10 is a view taken along line 10-10 of FIG. 5;

FIG. 11 is a view taken along line 11-11 in FIG. 9;

FIG. 12 is a view taken along line 12-12 in FIG. 9;

FIG. 13 is a view taken along line 13-13 in FIG. 10;

FIG. 14 is an enlarged sectional view showing three blanks being punched locked in the first press operation;

FIG. 15 is a view taken along line 15-15 in FIG. 8;

FIG. 16 is an enlarged partial perspective view of the assembly formed by the first press operation;

FIG. 17 is a partial perspective view of a formed blank that is part of an alternative embodiment of the invention;

FIG. 18 is a partial perspective view of an engine cradle that is an alternative embodiment of the invention;

FIG. 19 is a partial perspective view of an engine cradle that is another alternative embodiment of the invention;

FIG. 20 is a top view of a truck frame constructed in accordance with the present invention;

FIG. 21 is a side view of the truck frame of FIG. 20;

FIG. 22 is an enlarged sectional view taken along line 22-22 of FIG. 21;

FIG. 23 is a view like FIG. 22 and shows an alternative embodiment;

FIG. 24 is a perspective view illustrating a joint at the overlap of a lower front siderail and a lipped center siderail according to the present invention;

FIG. 25 is a cross-sectional view taken along line 25-25 in FIG. 24;

FIG. 26 is a front detail view of a portion of FIG. 24;

FIG. 27 is a perspective view illustrating an alternative joint design at the intersection of the front siderail and a lipped center siderail; and

FIG. 28 is a cross-sectional view taken at line 28-28 in FIG. 27.

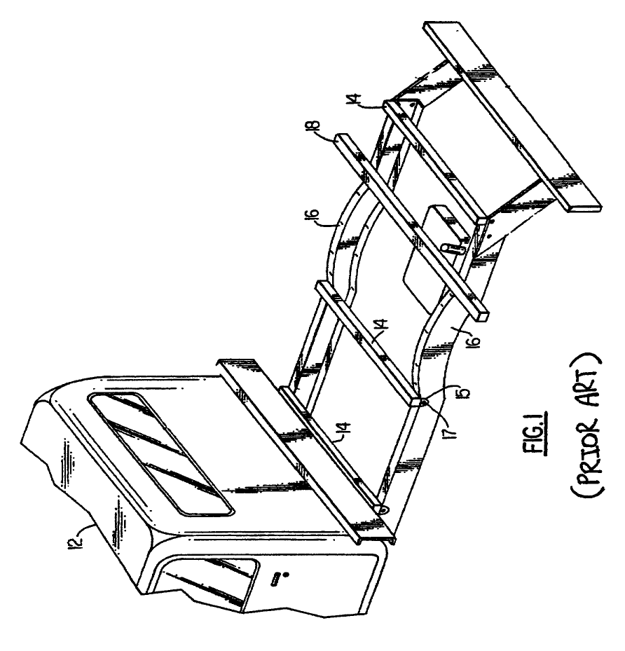

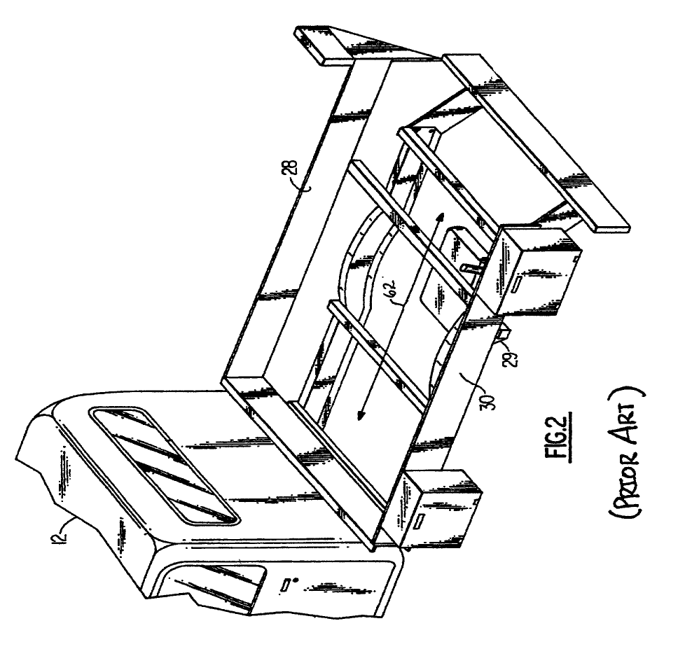

### V. DETAILED DESCRIPTION OF A PREFERRED EMBODIMENT

a. The Integrated Rear Frame/Box Floor and a Method of Manufacture

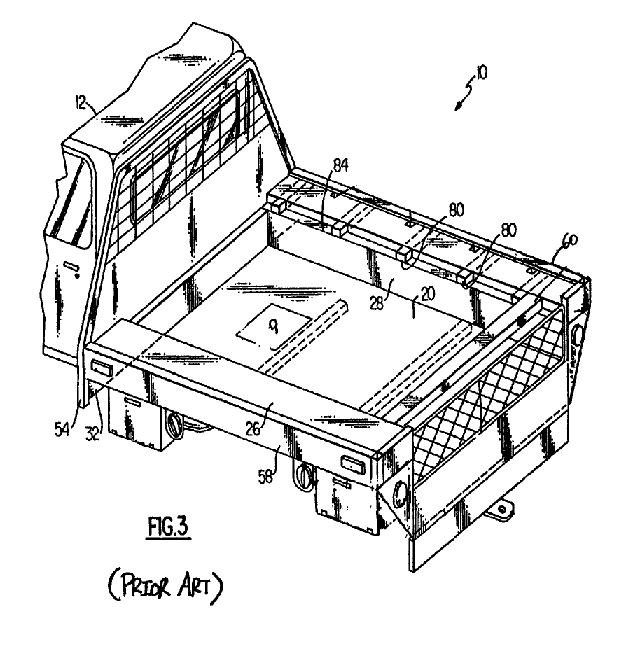

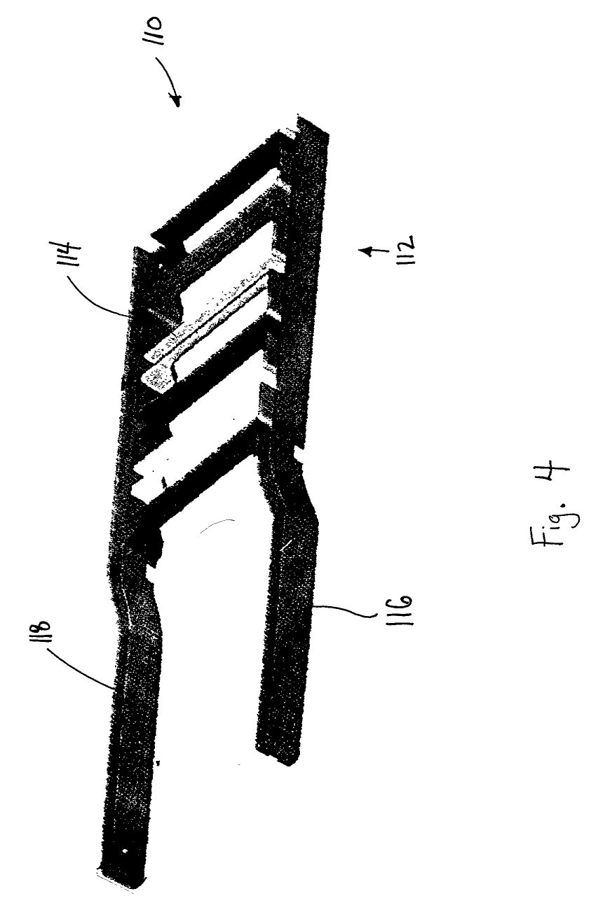

FIG. 4 illustrates an improved rear structure 110 in which the rear frame structure and the pickup box floor structure are integrated into a unitary structure 112. The structure includes a system of inverted “hat” sections 114 that have all required frame mounting points, for the suspension, fuel tank, exhaust, etc. The “hat” sections are integrally formed with center rails 116 and 118.

In a presently preferred embodiment, the integrated rear structure is simultaneously formed and joined in a single press stroke from loose blanks into a lattice of interlocking “hat” sections. This structure is joined to the pickup box by conventional means, such as by spot welding or any other fastening method known in the art. The unitary structure is welded to, and boxed by, the pickup box floor (not shown). For purposes of simplicity, the process of simultaneously forming and joining a structure from loose blanks in a single stroke may be referred to as “simulform.”

U.S. Pat. No. 5,487,219, which is entitled Method of Manufacturing Engine Cradles and which is incorporated by reference herein, illustrates a method for forming a multimember automobile structure in a single press stroke.

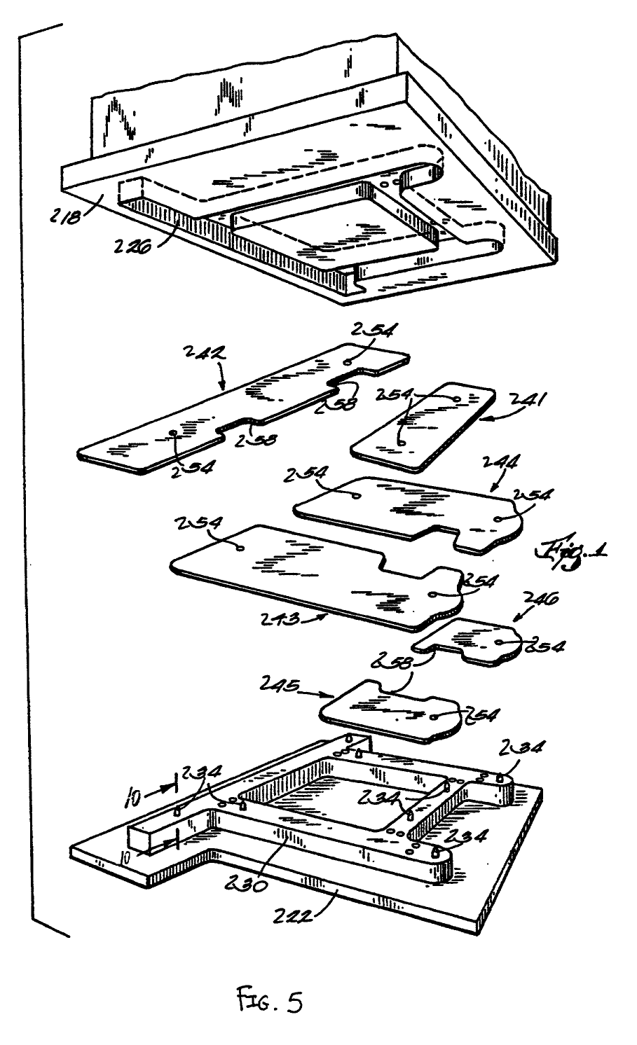

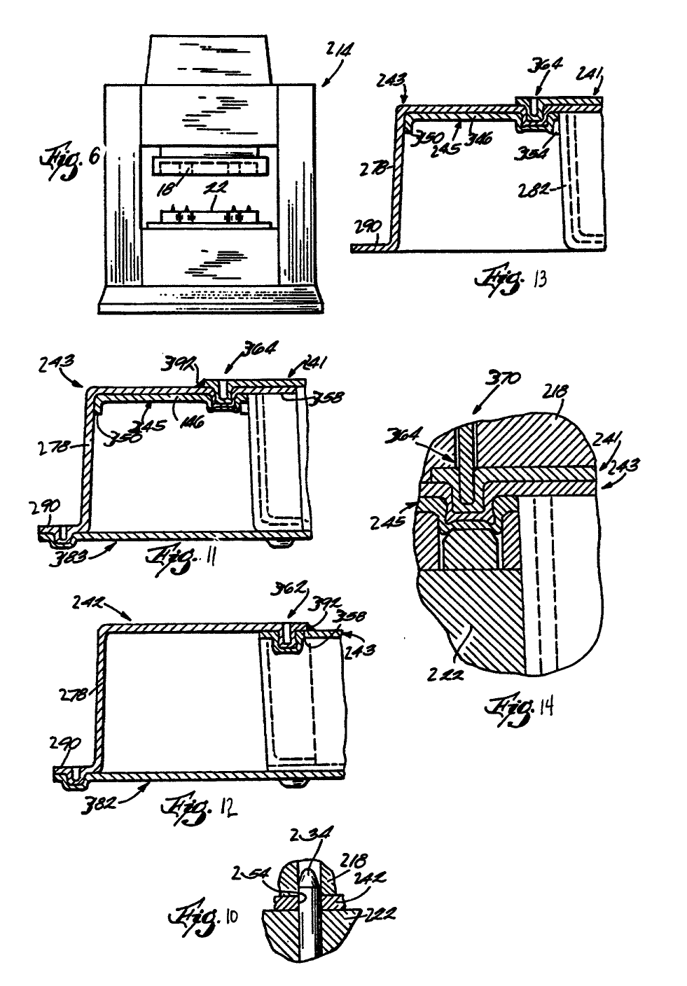

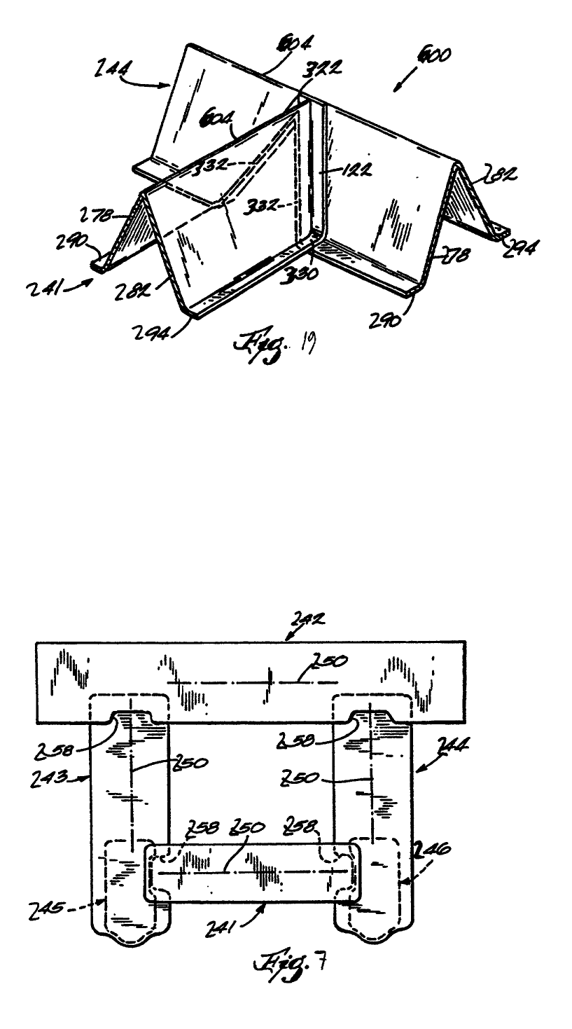

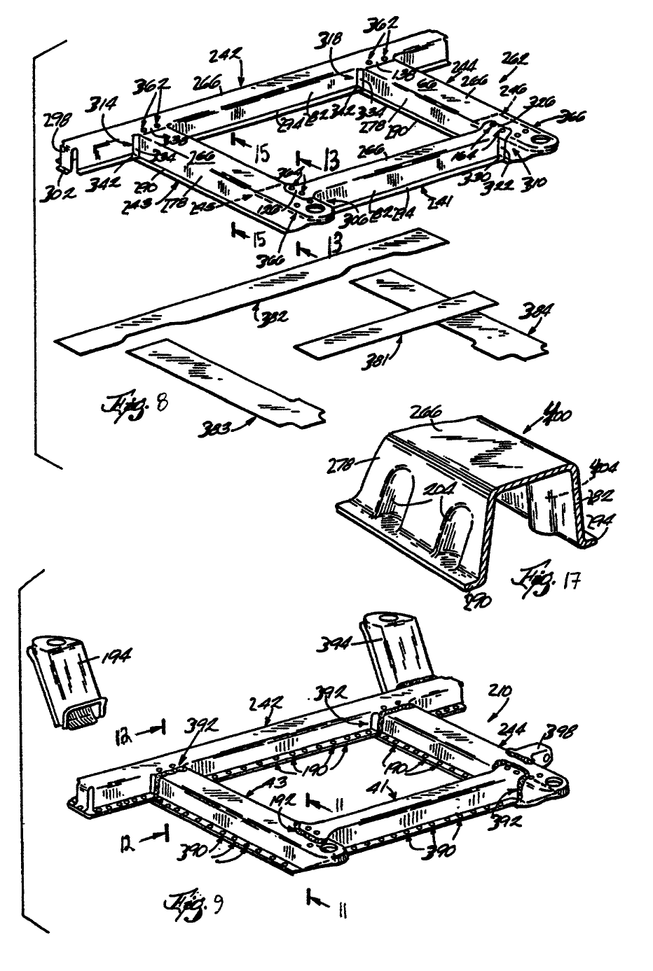

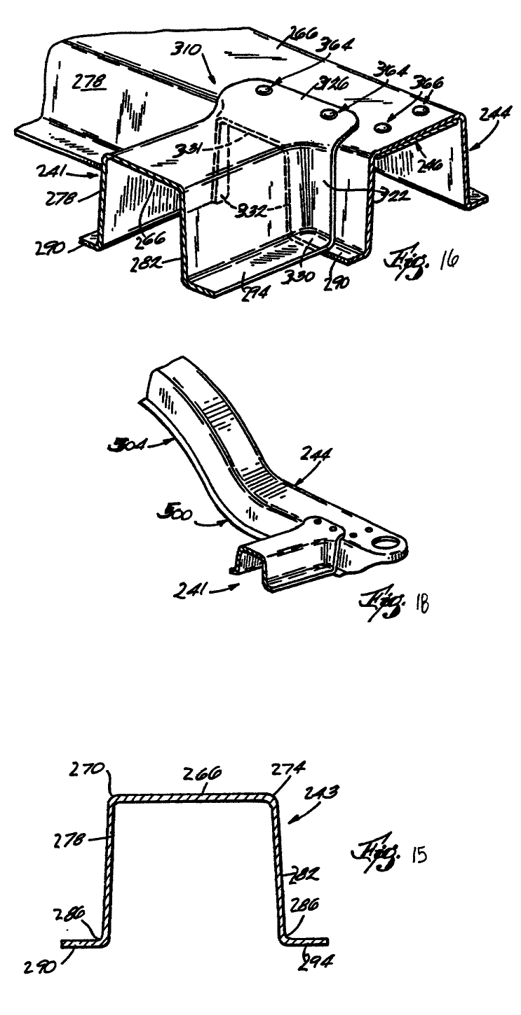

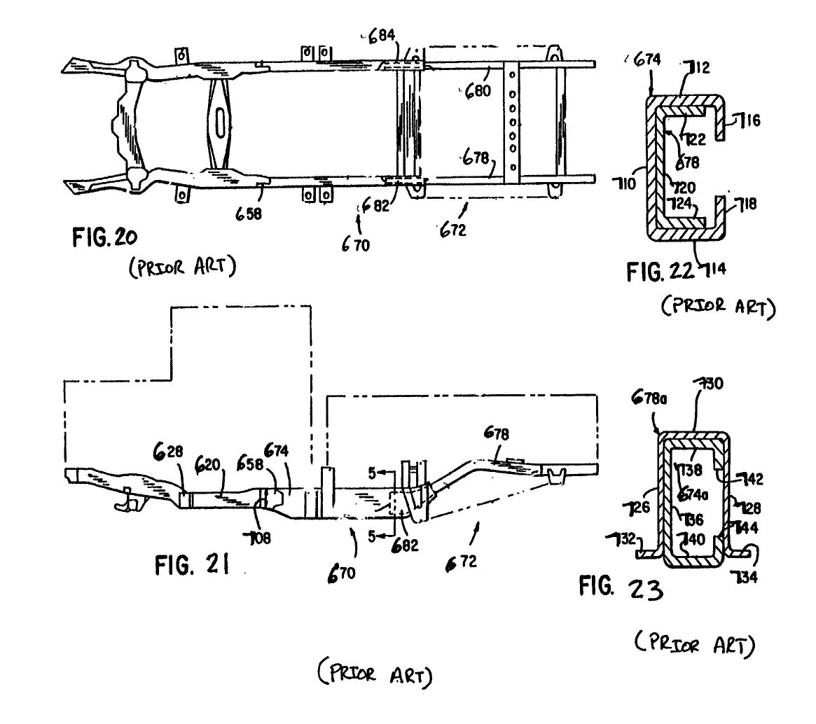

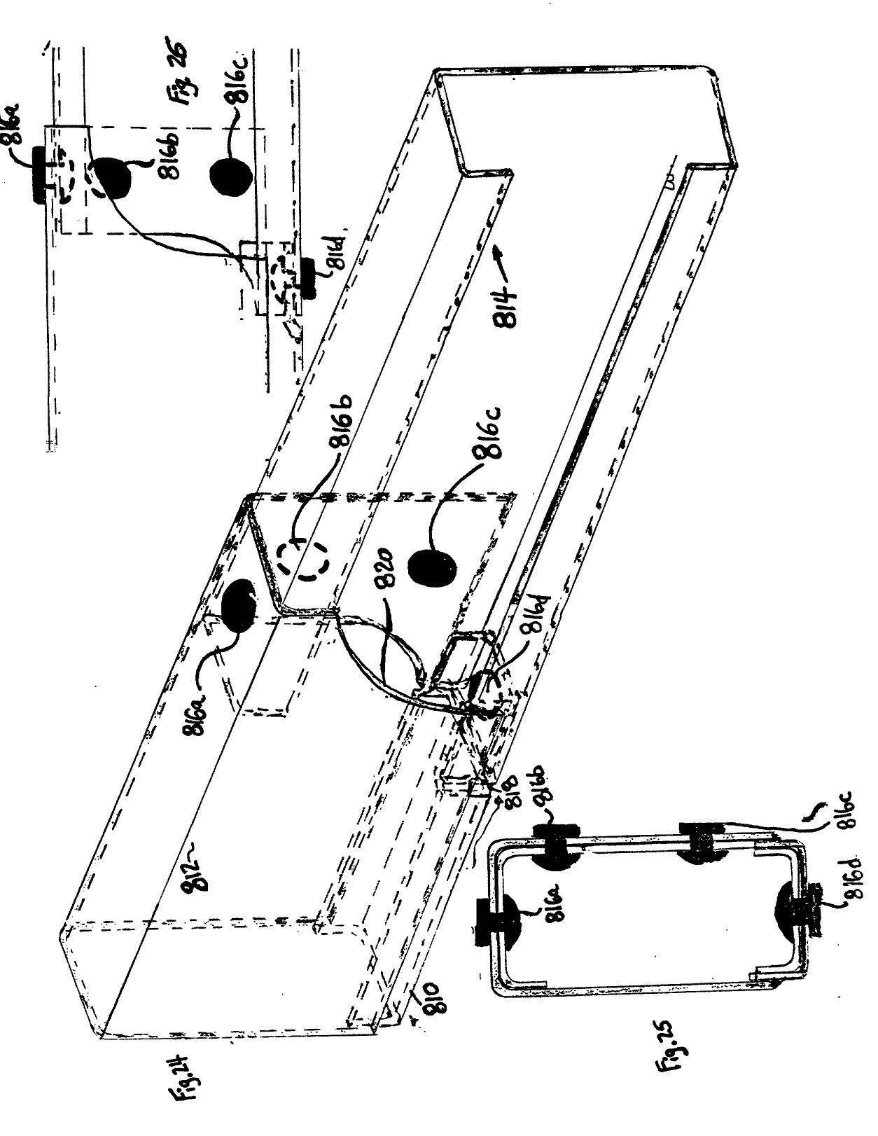

A structural member such as an engine cradle 210 (see FIG. 8) is manufactured as follows in accordance with the invention. A stamping press 214 employed in the manufacturing process is illustrated in FIG. 6. The press 214 itself is conventional and will not be described in detail. As is known in the art, the press 214 can be closed to move upper and lower die halves 218 and 222 together.

The die halves 218 and 222 are illustrated in greater detail in FIG. 5. The upper die half 218 has therein a recess 226, and the lower die half 222 has thereon a complementary projection 230. The projection 230 has thereon (see FIGS. 5 and 6) pins 234 which, as is known in the art, move into recesses (not shown) in the upper die half 218 when the press 214 is closed so as to orient blanks on the lower die half 222, as will be explained hereinafter.

As shown in FIGS. 5 and 7, six sheet metal blanks or members 241, 242, 243, 244, 245 and 246 are placed on the lower die half 222. The blanks 241, 242, 243 and 244 are elongated and are referred to hereinafter as “top sheets.” By “elongated” it is meant that each top sheet 241, 242, 243 or 244 has (see FIG. 7) a longitudinal axis 250 and a maximum length dimension greater than its maximum width dimension. The sheets 241 and 242 are generally parallel and spaced apart, and the sheets 243 and 244 are generally parallel and spaced apart. Thus, the longitudinal axes 250 of the sheets 241 and 242 are transverse to the longitudinal axes 250 of the sheets 243 and 244. In other words, the length dimensions of the sheets 241 and 242 are angled relative to the length dimensions of the sheets 243 and 244. The axes 250 of the sheets 241 and 242 are preferably perpendicular to the axes 250 of the sheets 243 and 244. As best shown in FIG. 7, one end of the sheet 241 partially overlaps the sheet 243, the opposite end of the sheet 241 partially overlaps the sheet 244, and spaced portions of the sheet 242 partially overlap ends of the sheets 243 and 244. It should be noted that none of the sheets 241, 242, 243 and 244 is completely overlapped by another sheet.

The blanks 245 and 246, referred to hereinafter as “reinforcement blanks,” are also placed on the lower die half 222. The reinforcement blank 245 is located beneath an end of the sheet 243, and the reinforcement blank 246 is located beneath an end of the sheet 244.

Each of the top sheets 241, 242, 243 and 244 and each of the reinforcement blanks 245 and 246 has there through (see FIG. 5) one or more apertures 254. Each aperture 254 receives (see FIG. 10) a respective pin 234 on the lower die half 222. The pins 234 orient the top sheets 241, 242, 243 and 244 and reinforcement blanks 245 and 246 relative to the die half 222, as is known in the art. One edge of the sheet 242 has therein (see FIG. 5) spaced indentations 258, and one edge of each of the sheets 243 and 244 and the reinforcement blanks 245 and 246 has therein an indentation 258. The reason for the indentations 258 is explained below.

After the top sheets 241, 242, 243 and 244 and the reinforcement blanks 245 and 246 are properly located on the lower die half 222, the press 214 is closed. Closing of the press 214 forms the top sheets 241, 242, 243 and 244 and the reinforcement blanks 245 and 246 into an assembly 262 that is illustrated in FIG. 8. More particularly, each of the top sheets 241, 242, 243 and 244 is formed so as to have a hat-shaped cross section along substantially the entire length thereof. The cross sections of the sheets 241, 242, 243 and 244 are substantially identical, and only the cross section of the sheet 243 will be described in detail. The hat-shaped cross section of the sheet 243 is illustrated in FIG. 15. The top sheet 243 is formed so as to have a generally planar top wall 266 with opposite edges 270 and 274 extending parallel to the longitudinal axis 250 of the formed sheet. The sheet 243 also has a generally planar side wall 278 extending downwardly from the edge 270 of the top wall 266, and a generally planar side wall 282 extending downwardly from the opposite edge 274 of the top wall 266. The side walls 278 and 282 are generally perpendicular to the top wall 266, although the side walls 278 and 282 preferably diverge slightly, as shown in FIG. 15. Each of the side walls 278 and 282 has a lower edge 286. The top sheet 243 also has a flange 290 extending outwardly from the lower edge 286 of the side wall 278, and a flange 294 extending outwardly from the lower edge 286 of the side wall 282. The flanges 290 and 294 are generally co-planar and parallel to the top wall 266.

As shown in FIG. 8, the sheet 242 is also formed to have an end wall 298 extending downwardly from one end of the top wall 266, and an end wall (not shown) extending downwardly from the opposite end of the top wall 266. The lower end of each end wall 298 has thereon an outwardly extending flange 302. Closing of the press 214 forms (see FIG. 8) a joint 306 between the formed sheets 241 and 243, a joint 310 between the formed sheets 241 and 244, a joint 314 between the formed sheets 242 and 243, and a joint 318 between the formed sheets 242 and 244.

At the joints 306 and 310, as shown in FIGS. 8 and 16, integral extensions 322 of the side walls 278 and 282 of the sheet 241 are bent outwardly and overlap side walls of the sheets 243 and 244, integral extensions 326 of the top wall 266 of the sheet 241 overlap the top walls 266 of the sheets 243 and 244, and integral extensions 330 (only one is shown) of the flanges 290 and 294 of the sheet 241 overlap flanges of the sheets 243 and 244. Additionally, referring to FIG. 16 in which the joint 310 is shown, an integral extension 331 of the top wall 266 of the sheet 244 extends beneath the top wall of the sheet 241, and integral extensions 332 of the side wall 278 of the sheet 244 are bent outwardly and extend generally perpendicular to the side wall 278 of the sheet 244 and inside the side walls 278 and 282 of the sheet 241. The joint 306 is similarly formed and will not be described in detail.

At the joints 314 and 318 (see FIG. 8), integral extensions 334 (two are shown) of the side wall 282 of the sheet 242 are bent outwardly and overlap the ends of the side wails of the sheets 243 and 244, integral extensions 338 of the top wall 266 of the sheet 242 overlap the top walls 266 of the sheets 243 and 244, and integral extensions 342 (two are shown) of the flange 294 of the sheet 242 overlap the flanges of the sheets 243 and 244.

Closing of the press 214 forms each of the reinforcement blanks 245 and 246 into an inverted U-shape, as best shown in FIG. 13, with each reinforcement blank having a top wall 346 abutting the underside of the top wall 266 of the associated top sheet, a downwardly extending flange 350 abutting the inside of one side wall of the associated top sheet, and a downwardly extending flange 354 abutting the inside of the other side wall of the associated top sheet.

The indentations 258 in the top sheets 242, 243 and 244 and in the reinforcement blanks 245 and 246 provide (see FIGS. 11 and 12) openings 358 in the side walls of the formed sheets 242, 243 and 244. The openings 358 in the formed sheet 242 (see FIG. 12) receive the ends of the formed sheets 243 and 244, and the openings 358 in the sheets 243 and 244 (see FIG. 11) are aligned with the ends of the sheet 241. Thus, the inside of each of the formed sheets 241, 242, 243 and 244 is open to the inside of the adjacent sheets. Without the indentations, the stretch in these openings would be too great and forming splits would occur.

In addition to forming the top sheets 241, 242, 243 and 244 and the reinforcement blanks 245 and 246 as described above, the first press operation also forms (see FIGS. 8, 9 and 12) punch-locks 362 between the top wall 266 of the sheet 243 and the overlapping extension 338 of the top wall 266 of the sheet 242, punch-locks 362 between top wall 266 of the sheet 244 and the overlapping extension 338 of the top wall 266 of the sheet 242, punch-locks 364 between the reinforcement blank 245, the top wall 266 of the sheet 243, and the overlapping extension 326 of the top wall 266 of the sheet 241, punch-locks 364 between the reinforcement blank 246, the top wall 266 of the sheet 244, and the overlapping extension 326 of the top wall 266 of the sheet 241, punch-locks 366 between the top wall 266 of the sheet 243 and the top wall of the reinforcement blank 245, and punch-locks 366 between the top wall 266 of the sheet 244 and the top wall of the reinforcement blank 246. The punch-locks 362, 364 and 366 are created by respective punch-lock mechanisms 370, one of which is illustrated in FIG. 14. Such a punch-lock mechanism is known in the art and will not be described in greater detail. Suitable punch-lock mechanisms are disclosed in U.S. Pat. Nos. 3,359,935 and 3,579,809, both of which are incorporated herein by reference. In other embodiments, other securing means such as adhesives, spot welds, or other clinching shapes may be used.

In the preferred embodiment, the punch-locks are installed by mechanical or hydraulic means at the bottom of the form stroke, after the metal forming to shape is completed, but while the form tool still fixtures the parts in perfect alignment. This is done by the use of a two-stage press, as is conventionally known in the art. In addition, the second stage operation can be used to pierce holes in the frame, such as the body mount opening 247 shown in FIG. 8.

Along with being punch-locked together, adjacent members of the assembly 262 formed by the first press operation are also held together by frictional contact of the shaped overlapped portions of the members. After the first press operation, the assembly 262 created thereby is placed in a press with a different die (not shown). This press can be either the press 214 or a different press. Also placed in the press are (see FIG. 8) four elongated sheet metal blanks 381, 382, 383 and 384 referred to hereinafter “closing sheets.” The closing sheets 381, 382, 383 and 384 are located in the press in a manner similar to that in which the top sheets 241, 242, 243 and 244 were located in the press 214. The opposite ends of the closing sheet 381 partially overlap the closing sheets 383 and 384, and the closing sheet 382 partially overlaps the ends of the sheets 383 and 384. The sheets 381, 382, 383 and 384 are substantially the same size and shape as the bottoms of the formed sheets 241, 242, 243 and 244, respectively. After the closing sheets 381, 382, 383 and 184 are located in the press, the assembly 262 formed in the first press operation is placed on top of the closing sheets 381, 382, 383 and 384 so that the flanges of the formed top sheets 241, 242, 243 and 244 rest on top of the closing sheets 381, 382, 383 and 384, respectively. Pilot pins (not shown) may be used to align the assembly 262 relative to the closing sheets. The press is then closed.

Closing of the two-stage press forms punch-locks 390 (see FIG. 9) between the flanges of the formed top sheets 241, 242, 243 and 244 and the closing sheets 381, 382, 383 and 384. This closes the underside of each of the formed top sheets 341, 342, 343 and 344 and creates an assembly of four elongated, box-shaped structural frame members.

After the second press operation, the assembly created thereby is taken to a final assembly fixture (not shown) where the joints between top sheets 241, 242, 243 and 244 and the joints between closing sheets are arc welded (indicated by reference numeral 392 in FIG. 9) and where brackets can be attached to the assembly. Brackets 394 and 398 are shown welded to the assembly in FIG. 9. The arc welding of the overlap joints of the formed top sheet is greatly assisted by the perfect lap fit-ups created by their coincident forming.

A formed top sheet 400 which is an alternative embodiment of the invention is partially illustrated in FIG. 17. Except as described below, the top sheet is identical in cross-section to the top sheets 241, 242, 243 and 244, and common elements have been given the same reference numerals.

The top sheet 400 differs from the top sheets 241, 242, 243 and 244 in that each of the side walls 278 and 282 has therein spaced, indentations 404 such that the flanges 290 and 294 have sections of increased and decreased width alternately spaced along the length thereof. During the second press operation, punch-locks are formed adjacent the indentations 404. In other words, the flange sections of increased width are attached to the closing sheet.

The method may be adapted to form the unified rear pickup frame structure of the present invention. After forming, the structure can be painted along with the pickup box. The painted box/rear-frame would then be brought to the chassis build-up line, where a pre-coated front stub frame and pre-coated center frame siderails are added to make a complete frame. These joints could be welded, bolted, riveted, or otherwise connected. Aside from the change in attaching the pickup box, the chassis would be built in a conventional manner (e.g. inverted build first, then car-position).

There are several advantages to this approach. The integrated rear structure eliminates structural redundancy between the frame and the pickup box floor. As the frame is not currently isolated, there is no isolation to lose. Eliminating the structural redundancy reduces the weight of the truck, reduces cost and improves both cost and dimensional control.

The integrated rear structure also minimizes frame inventory at vehicle assembly plants. Some pick-up truck families have over 20 full-frame models that must be kept in inventory. In the present approach, only a much smaller inventory of common front ends need be kept in inventory. The front end is just over one third the size of an assembled frame. Wheelbase and GVW variations are accommodated by using different, loose center siderails.

In the best case, only 1/60 of the frame stack area is required.

The present approach also enhances the dimensional control of the rear structure. The stack of tolerances is reduced by forming the rear structure in a single stroke. There is just one unified structure rather than both a box and frame.

There are various other advantages to the present approach. The integrated rear structure may allow the pickup box to be lower than in conventional designs, as the vertically stacked structures are integrated. The depth of the box could be increased at the same top box height, or the top could also be lowered.

The cost of the box floor reinforcement is reduced through use of the single-stroke “simulform” approach. The frame paint facility would be about 1/3 of the size of a conventional frame paint facility. The user could thereby reduce capital and floor space needs. Shipping costs would be significantly reduced, as the cost of shipping the 1/3-sized front frame is much less than the cost of shipping a full frame.

A further advantage is that the vehicle assembly plant build sequence and layout would be very similar to the current arrangements. The pickup truck box would need to be accommodated on the chassis line, but otherwise the line would be similar to existing arrangements.

With a three-piece siderail design, the rear structure is easily replaceable. In case of an accident, for example, a new rear structure may be substituted for the damaged structure.

Three piece siderail designs are disclosed in U.S. Pat. Nos. 5,149,132 and 5,308,115, which are incorporated by reference.

Additionally, the unitary, frame-integral-to-box design of the present invention should yield a stiffer rear frame structure than can be achieved with a bolt tie-down design.

b. Side Rail Designs

As discussed above, the preferred embodiment of the present invention includes a three piece siderail design. However, the simulform approach described herein can be used in conjunction with a variety of siderail designs. Examples herein of specific sideframe systems are given by way of illustration, and not limitation.

U.S. Pat. No. 5,149,132 illustrates one prior art siderail design. The rear siderails are broken into two members that overlap at a joint. The joint is then double thickness at the overlapped portion, thereby making the joint considerably stronger than a comparable single thickness design. The side rail members are each short enough so that they can be cut from a six foot steel coil. The frame has three main portions: a front portion, a center portion and a rear portion. The front portion is joined to the center portion at joint 658, while the rear portion is joined to the center portion at joint 682.

Referring to FIGS. 20 and 21, a frame has siderails 678 and 680. A front frame 716 and a rear frame having a front portion 670 and a rear portion 672. There are joints 658 and 660 at the junction points of front frame 616 and front portion 670, and overlap joints 682 and 684 at the junction points of rear portion 672 and front portion 670.

FIG. 22 is a cross-section view of the overlap joint 682 taken about section 22-22 of FIG. 20. In the embodiment of FIG. 22, siderail 674 is a c-shaped member with web section 710 extending vertically between top and bottom end segments 712 and 714 having inner inwardly turned lipped flanges 716 and 788. Siderail 678 is nested within siderail 674 at overlap joint 682 and is a c-shaped member having a web section 720 extending vertically between top and bottom end segments 722 and 724, which end segments do not have inner inwardly lipped flanges such as 716 and 718.

In the embodiment of FIG. 23, siderail 678a of rear portion 678 has a hat-shape cross-section of reduced stock thickness, with sections 726 and 728 extending vertically between a top end segment 730 and lower horizontal flange segments 732 and 734. Siderail 674a of front portion 670 is nested within siderail 678a and has a web section 736 extending vertically between top and bottom end segments 738 and 740 having inwardly turned lipped flanges 742 and 744.

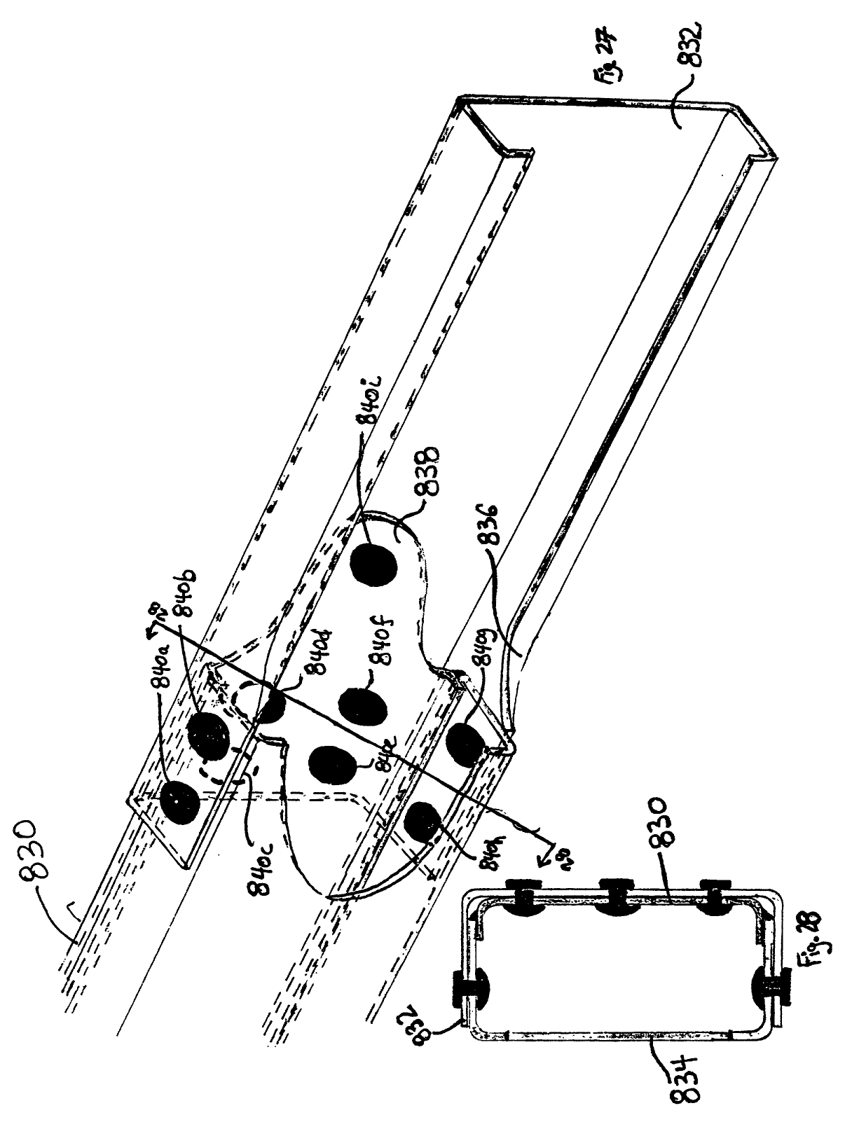

FIGS. 22 and 23 are cross-sections of prior art overlap joints. However, further invention is desirable for use in conjunction with the integrally-formed rear section of the frame of the present invention. FIGS. 24-26 illustrate a riveted or bolted front siderail splice, as would be used in “simulform” upper and lower half construction, or in “simulform” hat-to-cover-plate construction. This permits “warehouse” frame assembly of pre-painted front stub frames, to center and rear frame pre-pained details, or sub-assemblies, or to a stub rear frame.

By way of example and not of limitation, FIGS. 24-28 illustrate new and useful sideframe systems that may be used in conjunction with the simulform manufacturing method described herein. FIG. 24 is a perspective view illustrating a joint at the overlap of a lower front siderail 810, an upper front siderail 812 and a lipped center siderail 814 according to one embodiment of the present invention. The front upper siderail 812 is riveted to the lipped center siderail 814 at rivets 816a, b, and c. The lower front siderail 810 is riveted to the lipped center siderail 814 at rivet 816d. As alternatives to riveting, the siderails may be bolted, welded, or joined in any other suitable manner known in the art.

The lower front siderail 810 includes a step 818 at the transition to the open center siderail. The lipped center siderail 814 includes a scallop 820 to improve clearance and reduce stress concentrations. The scalloped joint can be adapted for use with a boxed or tubular center siderail. The center-to-rear siderail splice joint (not shown) could follow the same design as the joint in FIG. 24. The center-to-rear siderail splice joint would preferably be a hat-with-cover design, or an over/under-type design.

The walls of the front upper siderail 812 may have a slight taper of approximately 2°-3° to ease assembly.

FIGS. 27-28 illustrate a riveted or bolted front splice of a three piece siderail. FIG. 27 is a perspective view illustrating an alternative joint design at the intersection of the outer front siderail 830, a lipped center siderail 832, and the inner front siderail 834. The lipped center siderail 832 has a lip roll-out 836 at the transition to an open center. The outer front siderail 830 includes a tongue 838 to the open center siderail. The components are secured to one another with rivets 840a-i or other connecting means known in the art.

This embodiment has a typical overlap rear splice at the rear-spring-front-hanger. This would permit a “warehouse” frame assembly of pre-painted front stub frames to pre-painted rear details, sub-assemblies, or rear stub frames using only simple bolt/rivet fixtures.

c. Conclusion

The foregoing has described presently preferred embodiments of the invention, as well as alternative embodiments. However, it should be understood that the scope of the invention is not limited to what is described in the Detailed Description. Numerous variations may be employed within the scope of the invention. For example, the siderails may be two pieces rather than three. That is, the front siderail may be a single long siderail that interconnects directly with the rear siderails, without any center siderails in between. Alternatively, the siderail may be one long and continuous siderail, with some or all of the crossmembers being integrally formed with the siderail in a large die press.

The front and center siderails may also be integrally formed in a press with respective cross members. A function of the rear crossmembers would be to support the truck bed and to provide support for various truck components. The integrally-formed crossmembers of the center and/or front portions of the frame would typically not support the truck bed but would provide support for various truck components. The front and center siderails may be interconnected with crossmembers that are not integrally formed with the siderails, but which are instead interconnected by conventional means.

Accordingly, the present invention is not limited precisely to the arrangements as shown in the drawings and as described in detail hereinabove.

What is claimed is:

1. A method for efficiently manufacturing a vehicle frame comprising the steps of:
forming a rear vehicle frame by placing a plurality of sheet members in a die in a press, at least some of said members at least partially overlapping other of said members, and then closing said press, thereby interlocking said members to form a rear vehicle frame having first and second siderails and at least one crossmember extending between said siderails, said crossmember comprising a floor reinforcement;
after the step of forming a rear vehicle frame, attaching said siderails to first and second front siderails.

2. A method for efficiently manufacturing a vehicle frame as defined in claim 1, wherein said first and second siderails overlap a portion of said first and second front rails, at least one of said first and second front rails comprising a scallop at the overlapped portion.

3. A method for efficiently manufacturing a vehicle frame as defined in claim 1, wherein said front siderails each comprise an upper front siderail and a lower front side rail.

4. A method for efficiently manufacturing a vehicle frame as defined in claim 3, wherein there is a step in between said siderails and said lower front siderails.

5. A method for efficiently manufacturing a vehicle frame as defined in claim 4, wherein at least one of said upper front siderails has a scallop at one edge.

6. A method for efficiently manufacturing a vehicle frame as defined in claim 1, wherein said front siderails are lipped and wherein at least a portion of said front siderails is open.

7. A method for efficiently manufacturing a vehicle frame as defined in claim 1 wherein said front upper siderails comprise tapered walls.

8. A method for efficiently manufacturing a vehicle frame as defined in claim 1 wherein said siderail has a lip, and said lip rolls out at a transition to said front siderail.

9. A method for efficiently manufacturing a vehicle frame as defined in claim 1 wherein said front siderail comprises a tongue that is adapted to be attached to said center siderail.

10. A method for efficiently manufacturing a vehicle frame as defined in claim 1, wherein said siderails comprise rear siderails that have been attached to center siderails and wherein the step of attaching said siderails to first and second front siderails comprises attaching the center siderails to the front siderails.

11. A method for efficiently mounting a pickup truck bed to a rear pickup truck frame comprising the steps of:
forming a rear vehicle frame by placing a plurality of sheet members in a die in a press, at least some of said members at least partially overlapping other of said members, and then closing said press, thereby interlocking said members to form a rear vehicle frame having first and second siderails and a plurality of crossmembers extending between and interconnecting with said siderails;
mounting a pickup truck bed directly on said crossmembers.

12. A method for efficiently mounting a pickup truck bed to a rear pickup truck frame as defined in claim 11 wherein the method further comprises the step of attaching said rear vehicle frame to first and second center rails.

13. A method for efficiently mounting a pickup truck bed to a rear pickup truck frame as defined in claim 12 wherein the method further comprises the step of attaching said first and second center rails to first and second front rails, respectively.

14. A method for efficiently mounting a pickup truck bed to a rear pickup truck frame as defined in claim 13, wherein said first and second center rails overlap a portion of said first and second front rails, at least one of said first and second front rails comprising a scallop at the overlapped portion.

15. A method for efficiently mounting a pickup truck bed to a rear pickup truck frame as defined in claim 13, wherein said front siderails each comprise an upper front siderail and a lower front side rail.

16. A method for efficiently mounting a pickup truck bed to a rear pickup truck frame as defined in claim 15, wherein there is a step in between said center side rail and said lower front side rail.

17. A method for efficiently mounting a pickup truck bed to a rear pickup truck frame as defined in claim 15, wherein at least one of said upper front siderail has a scallop at one edge.

18. A method for efficiently mounting a pickup truck bed as defined in claim 13, wherein said center siderails are lipped and wherein at least a portion of said center siderails is open.

19. A method for efficiently mounting a pickup truck bed as defined in claim 13 wherein said front upper siderails comprise tapered walls.

20. A method for efficiently mounting a pickup truck bed as defined in claim 13 wherein a said center siderail has a lip, and said lip rolls out at a transition to said front siderail.

21. A method for efficiently mounting a pickup truck bed as defined in claim 13 wherein said front siderail comprises a tongue that is adapted to be attached to said center siderail.

22. A space-efficient method for manufacturing a vehicle frame comprising the steps of:
manufacturing a vehicle front frame at a first facility;
transporting the vehicle front frame to a second facility;
forming a rear vehicle frame at the second facility by placing a plurality of sheet members in a die in a press, at least some of said members at least partially overlapping other of said members, and then closing said press, thereby interlocking said members to form a rear vehicle frame having first and second siderails and a plurality of crossmembers extending between and interconnecting with said siderails;
interconnecting said rear vehicle frame and said front frame at said second facility to form a full vehicle frame.
